(19) United States
(12) Patent Application Publication
(10) Pub. No.: US 2025/0285360 A1
(43) Pub. Date: Sep. 11, 2025

(54) METHODS AND PROCESSORS FOR DIFFERENTIABLE RENDERING OF THREE DIMENSIONAL GAUSSIANS FOR OMNIDIRECTIONAL CAMERAS

(71) Applicant: HUAWEI TECHNOLOGIES CO., LTD., Shenzhen (CN)

(72) Inventors: Yuan REN, Markham (CA); Xingxin CHEN, Markham (CA); Guile WU, Markham (CA); Bingbing LIU, Beijing (CN)

(21) Appl. No.: 18/891,649

(22) Filed: Sep. 20, 2024

Related U.S. Application Data
(60) Provisional application No. 63/561,876, filed on Mar. 6, 2024.

(51) Int. Cl. G06T 15/10; G06T 15/08; G06T 19/20

(52) U.S. Cl. CPC G06T 15/10; G06T 15/08; G06T 19/20; G06T 2219/2012; G06T 2219/2016

(57) ABSTRACT

Methods and processors for rendering a 3D Gaussian are disclosed. The processor is configured to acquire the 3D Gaussian to be rendered, and a camera model representing an omnidirectional camera with an optical axis, updating a color of the 3D Gaussian using spherical harmonics, update a position of the 3D Gaussian by moving the 3D Gaussian towards the optical axis, update a scale of the 3D Gaussian by compressing the 3D Gaussian in at least one of a tangential direction and a polar direction relative to the optical axis, and render an updated 3D Gaussian onto a 2D plane using a 3DGS model.

### CROSS-REFERENCE

The present application claims priority on U.S. patent application No. 63/561,876, entitled “METHODS AND PROCESSORS FOR DIFFERENTIABLE RENDERING OF 3D GAUSSIANS FOR OMNIDIRECTIONAL CAMERAS”, filed on Mar. 6, 2024, and the contents of which are incorporated herein by reference in its entirety.

### FIELD

The present technology relates generally to image rendering, and more particularly, to differentiable rendering of three dimensional (3D) Gaussians for omnidirectional cameras.

### BACKGROUND

Omnidirectional cameras may be used in various fields such as robotics and autonomous driving. For example, a mobile robot may use a catadioptric camera to capture images which provide 360-degree field of view in the horizontal plane and more than 100 degrees in elevation. In a second example, fisheye cameras, which are a type of dioptric cameras, are used in autonomous driving applications for near-field sensing and automatic parking. It should be noted that, in comparison with pinhole cameras, omnidirectional cameras provide higher data collection efficiency, suffer less from errors due to multi-sensor calibration, and synchronize naturally.

3D scene reconstruction is used in a variety of applications, including autonomous driving. In order to perform 3D reconstruction, a suitable representation of the 3D scene and a rendered may be needed. Neural Radiance Field (NeRF) can be used to that end and has a good performance in reconstruction and rendering of pinhole cameras. In an article entitled “S-Nerf: Neural Radiance Fields For Street Views”, authored by Ziyang Xie et al., and published in 2023, incorporated herein in its entirety, there is disclosed a neural rendering pipeline for performing neural rendering of camera data. NeRF can also be adapted for rendering of omnidirectional cameras. However, the slow rendering speed and the low editability caused by the implicit representation limit application of NeRF-based methods in real-time simulation.

3D Gaussian Splatting (3DGS) is a transformative technique in the explicit radiance field. It uses a large number of 3D Gaussians to approximate the 3D scene. In an article entitled “3D Gaussian Splatting for Real-Time Radiance Field Rendering”, authored by Bernhard Kerbl et al., and published on Aug. 8, 2023, herein incorporated by reference in its entirety, there is disclosed one or more architecture for implementing a 3DGS model. 3DGS has a comparatively faster rendering speed than NeRF, making it a better candidate for real-time applications. This is due at least in part to avoiding massive queries of the empty space in NeRF and several techniques can be utilized accelerate parallel computation of 3DGS. However, 3DGS is ill-suited for 3D scene reconstruction of other types of cameras than pin-hole cameras.

### SUMMARY

Developers have devised methods and processors for overcoming at least some drawbacks present in prior art solutions.

Developers of the present technology have realized that conventional 3DGS models cannot be used for 3D reconstruction of omnidirectional cameras. Due to the twisting of the lens or mirror against the light destroys the affine transformation from 3D space to two dimensional (2D) image plane, and therefore the 2D projection of a 3D Gaussian no longer follows a normal distribution. This effect of omnidirectional cameras on light violates an assumption of conventional 3DGS models used for efficient parallel computing.

Developers have realized at lease some advantages of 3DGS in comparison to NeRF based methods. First, splatting is an affine transformation, and therefore the 2D projection of 3D Gaussians is a Gaussian distribution. As a result, the covariance matrix can be computed relatively easily. Second, tiles are positioned on a grid evenly divided on a two-dimensional plane, and therefore detection of the tiles which intersect with the projected Gaussians is a parallelizable process. Third, parallel computation of the probability density function (PDF) of 2D Gaussian distribution can be computed efficiently by a Graphical Processing Unit (GPU) since the 2D projection of 3D Gaussians is a Gaussian distribution.

Developers have realized that rendering methods for omnidirectional cameras have not been studied as a separate framework from rendering methods of pinhole cameras because there are limited differences between rendering of an omnidirectional camera and rendering of a pinhole camera for a scene represented by 3D mesh or neural radiance field.

However, when the rendering methods for 3D mesh or neural radiance field are further extended to 3DGS models, the rendering quality problem and parallelization problems may occur. For example, a method usually used for fisheye rendering includes rendering 5 to 6 cubic images. And then convert them to a fisheye image. Developers have realized that such a method may be well-suited for the scene represented by mesh. However, for the scene represented by 3D Gaussians, there is a noticeable difference in the joins of the images. The reason is that 3DGS model considers the 3D Gaussians near the frustum. Nevertheless, 3D Gaussians far from the frustum still have an impact on pixels near the edge of the image.

In the context of the present technology, rendering refers to the process of generating a 2D image from a 3D model by simulating how light interacts with surfaces.

In the context of the present technology, Gaussians refers to mathematical functions that describe smooth, bell-shaped curves used to represent objects in 3D space.

In the context of the present technology, splatting refers to a rendering technique where points or small shapes (e.g., 3D Gaussians) are projected onto a 2D plane to create an image.

In the context of the present technology, differentiability refers to the property of a rendering process where small changes in input parameters result in small, predictable changes in the output, enabling the efficient training of machine learning models.

In the context of the present technology, affine transformation refers to a linear mapping method that preserves points, straight lines, and planes. Examples include translation, rotation, scaling, and shearing.

In the context of the present technology, neural radiance field (NeRF) refers to a method using neural networks to create detailed 3D models from 2D images by predicting how light interacts with surfaces.

In the context of the present technology, 3D scene reconstruction refers to the process of creating a three-dimensional model of a scene from two-dimensional images captured by cameras, leveraging techniques such as 3D Gaussian splatting and neural radiance fields, for example.

In the context of the present technology, weight mask refers to a matrix applied during rendering to balance the convergence speeds of 3D Gaussians, ensuring consistent training and reducing artifacts in the final image.

In the context of the present technology, convergence rate refers to the speed at which a rendering or machine learning model reaches its optimal state, for ensuring efficient and accurate 3D scene reconstruction.

In the context of the present technology, omnidirectional camera refers to cameras that capture images that may provide a 360-degree field of view in the horizontal plane and more than 100 degrees in elevation.

In the context of the present technology, dioptric cameras refer to imaging systems that rely solely on lenses, without the use of mirrors, to focus light and form an image. These are the most common type of cameras, used in everyday photography, with lens elements arranged to correct aberrations and focus light.

In the context of the present technology, catadioptric cameras refer to imaging systems that use a combination of lenses and mirrors to form an image. This design enables a wide field of view with minimal distortion, making them suitable for panoramic imaging.

In the context of the present technology, fisheye cameras refer to imaging systems that use ultra-wide-angle lenses to capture an image that appears curved, resulting in a highly distorted, panoramic view. These cameras are employed for artistic effects, surveillance, and in scientific research where capturing a wide field of view is necessary.

In the context of the present technology, optical axis refers to the central line passing through the center of a camera lens system, defining the primary direction in which the camera is oriented.

In the context of the present technology, spherical harmonics refers to mathematical functions used to represent shapes and patterns on the surface of a sphere. In omnidirectional camera rendering, spherical harmonics are used for modeling how light behaves across a spherical surface.

In the context of the present technology, tangential direction refers to the direction that runs along the surface of a sphere, rather than pointing inward or outward from the sphere.

In the context of the present technology, polar direction refers to the direction that points outward from the center of a sphere toward its surface.

In the context of the present technology, scale of a Gaussian refers to the parameter that determines the spread of a Gaussian distribution in 3D space. This scale dictates the extent to which the Gaussian influences its surrounding area within the omnidirectional camera's rendered image.

In at least some embodiments of the present technology, there is provided differentiable rendering methods adapted to render images of omnidirectional cameras with a scene represented by a 3DGS model. These differentiable rendering methods may be suitable for a plurality of camera models that are continuous and differentiable. Examples of camera models that may be employed in at least some implementations of the present technology include a Kannala-Brandt model, MEI model, Scaramuzza model, an isometric projection model, and a stereographic projection model. In some embodiments, it can be said that that processors and methods disclosure herein may model the distortion of light caused by the omnidirectional camera via translation, rotation and stretching transformations of the 3D Gaussians.

Developers have realized that since these transformations are affine transformations, the parallelization strategy and the real-time performance of an original 3DGS model may not be affected. Furthermore, such pre-processing transformations are differentiable. Hence, the images of omnidirectional camera can be directly used for 3D reconstruction. It can be said that the distortion of light ray caused by omnidirectional camera may be simulated via pre-processing operations comprised of multiple affine transformations, which may not affect the parallelization strategy of 3DGS.

In some embodiments, a weight matrix may be employed by a processor to eliminate the problem of unbalanced convergence rates caused by the optical distortions of omnidirectional cameras. It can be said that a weight mask may be optionally applied to balance the gradients of 3D Gaussians projected on edge pixels.

The present technology may have a variety of advantages. First, by employing affine transformations such as translation, rotation, and stretching, the method can accurately simulate the light distortion caused by omnidirectional cameras while maintaining real-time performance and parallelization capabilities. Second, the use of high-order approximations for polar stretching ratios enhances the rendering quality, particularly for objects in close proximity to the camera, ensuring finer details are accurately represented. Third, the method's differentiability allows it to be directly used in training machine learning models, facilitating efficient and accurate 3D scene reconstruction. Fourth, the proposed method leverages the wide field of view and high data collection efficiency of omnidirectional cameras, making it suitable for large-scale scene reconstruction.

In a first broad aspect of the present technology, there is provided a method of rendering a 3D Gaussian, the method executable by a processor. The method comprises acquiring the 3D Gaussian to be rendered, and a camera model representing an omnidirectional camera with an optical axis. The method comprises updating a color of the 3D Gaussian using spherical harmonics. The method comprises updating a position of the 3D Gaussian by moving the 3D Gaussian towards the optical axis. The method comprises updating a scale of the 3D Gaussian by compressing the 3D Gaussian in at least one of a tangential direction and a polar direction relative to the optical axis. The method comprises rendering an updated 3D Gaussian onto a 2D plane using a 3DGS model.

It is contemplated that the present technology may improve the accuracy of rendering by updating the color, position, and scale of 3D Gaussians, ensuring that they align correctly with the optical properties of the camera.

In some embodiments of the method, the 3D Gaussian is a subset of 3D Gaussians, the omnidirectional camera further having a Field of View (FOV), and wherein the method further comprises acquiring a plurality of 3D Gaussians, selecting the sub-set of 3D Gaussians amongst the plurality of 3D Gaussians using the FOV, the selected sub-set being a visible subset of 3D Gaussians.

It is contemplated that the present technology may increase computational efficiency by selecting only the visible subset of 3D Gaussians, thereby reducing the overall computational load and improving real-time performance.

In some embodiments of the method, the updating the position of the 3D Gaussian comprises rotating a camera-Gaussian center vector of the 3D Gaussian towards the optical axis.

It is contemplated that the present technology may allow accurate alignment of 3D Gaussians with the camera's optical axis, thereby reducing rendering errors and improving the quality of the final image.

In some embodiments of the method, the method further comprises applying a weighted matrix on a rendered 3D Gaussian for controlling convergence speed of respective pixels of the rendered 3D Gaussian.

It is contemplated that the present technology may allow balancing the convergence speeds across different pixels, ensuring uniform rendering quality and preventing artifacts in the final image.

In some embodiments of the method, the updating the scale of the 3D Gaussian comprises generating at least one of a tangential scaling factor and a polar scaling factor, the polar scaling factor being model-specific to the camera model; and updating the scale based on the at least one of the tangential scaling factor and the polar scaling factor.

It is contemplated that the present technology may be used to scale 3D Gaussians according to the specific characteristics of the camera model, thereby enhancing the precision of the rendered image.

In some embodiments of the method, the updating the scale further includes generating a rescaled 3D Gaussian being smaller in size along the tangential direction than the 3D Gaussian.

It is contemplated that the present technology may improve the detail and clarity of the rendered image by resizing 3D Gaussians in the tangential direction.

In some embodiments of the method, the updating the scale further includes generating a rescaled 3D Gaussian being smaller in size along the polar direction than the 3D Gaussian.

It is contemplated that the present technology may increase image accuracy by adjusting the size of 3D Gaussians in the polar direction, catering to the specific requirements of different camera models.

In some embodiments of the method, the camera model is MEI camera model.

In some embodiments of the method, the camera model is Kannala-Brandt camera model.

In some embodiments of the method, the method further comprises generating a training dataset including the rendered 3D Gaussian, and training a machine learning model using the training dataset for 3D scene reconstruction.

In a second broad aspect of the present technology, there is provided a processor for rendering a 3D Gaussian. The processor is configured to acquire the 3D Gaussian to be rendered, and a camera model representing an omnidirectional camera with an optical axis, update a color of the 3D Gaussian using spherical harmonic, update a position of the 3D Gaussian by moving the 3D Gaussian towards the optical axis, update a scale of the 3D Gaussian by compressing the 3D Gaussian in at least one of a tangential direction and a polar direction relative to the optical axis, and render an updated 3D Gaussian onto a 2D plane using a 3DGS model.

In some embodiments of the processor, the 3D Gaussian is a subset of 3D Gaussians, the omnidirectional camera further having a Field of View (FOV), and wherein the processor is further configured to acquire a plurality of 3D Gaussians, and select the sub-set of 3D Gaussians amongst the plurality of 3D Gaussians using the FOV, the selected sub-set being a visible subset of 3D Gaussians.

In some embodiments of the processor, to update the position of the 3D Gaussian the processor is configured to rotate a camera-Gaussian center vector of the 3D Gaussian towards the optical axis.

In some embodiments of the processor, the processor is further configured to apply a weighted matrix on a rendered 3D Gaussian for controlling convergence speed of respective pixels of the rendered 3D Gaussian.

In some embodiments of the processor, to update the scale of the 3D Gaussian the processor is configured to generate at least one of a tangential scaling factor and a polar scaling factor, the polar scaling factor being model-specific to the camera model, and update the scale based on the at least one of the tangential scaling factor and the polar scaling factor.

In some embodiments of the processor, to update the scale the processor is further configured to generate a rescaled 3D Gaussian being smaller in size along the tangential direction than the 3D Gaussian.

In some embodiments of the processor, to update the scale the processor is further configured to generate a rescaled 3D Gaussian being smaller in size along the polar direction than the 3D Gaussian.

In some embodiments of the processor, the camera model is MEI camera model.

In some embodiments of the processor, the camera model is Kannala-Brandt camera model.

In some embodiments of the processor, the processor is further configured to generate a training dataset including the rendered 3D Gaussian and train a machine learning model using the training dataset for 3D scene reconstruction.

In another broad aspect, one or more non-transitory, computer-readable storage media is provided comprising computer-executable instructions, wherein the instructions, when executed, cause one or more processors to perform any of the methods provided herein. In particular, it may cause the one or more processors to acquire the 3D Gaussian to be rendered, and a camera model representing an omnidirectional camera with an optical axis, update a color of the 3D Gaussian using spherical harmonics, update a position of the 3D Gaussian by moving the 3D Gaussian towards the optical axis, update a scale of the 3D Gaussian by compressing the 3D Gaussian in at least one of a tangential direction and a polar direction relative to the optical axis and ender an updated 3D Gaussian onto a 2D plane using a 3DGS model.

In another aspect, embodiments of this disclosure provide a device configured to perform any of the methods disclosed herein.

In another aspect, embodiments of this disclosure provide an integrated circuit configure to perform any of the methods disclosed herein.

According to one aspect of this disclosure, there is provided a module comprising: one or more circuits for performing any of the methods disclosed herein.

According to one aspect of this disclosure, there is provided an apparatus comprising: one or more processors functionally connected to one or more memories for performing any of the methods disclosed herein.

According to one aspect of this disclosure, there is provided an apparatus configured to perform any of the methods disclosed herein. In some embodiments the apparatus comprises one or more units configured to perform the above-described method.

According to one aspect of this disclosure, there is provided one or more non-transitory, computer-readable storage media comprising computer-executable instructions, wherein the instructions, when executed, cause at least one processing unit, at least one processor, or at least one circuits to perform any of the methods disclosed herein.

According to one aspect of this disclosure, there is provided one or more computer-readable storage media storing a computer program, wherein, when the computer program is executed by an apparatus, the apparatus is enabled to implement any of the methods disclosed herein.

According to one aspect of this disclosure, there is provided a computer program product including one or more instructions, wherein, when the instructions are executed by an apparatus, the apparatus is enabled to implement any of the methods disclosed herein.

According to one aspect of this disclosure, there is provided a computer program, wherein, when the computer program is executed by a computer, an apparatus is enabled to implement any of the methods disclosed herein.

According to one aspect of this disclosure, there is provided a system comprising a node for performing any of the methods disclosed herein.

In the context of the present specification, a “server” is a computer program that is running on appropriate hardware and is capable of receiving requests (e.g., from devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “device” is any computer hardware that is capable of running software appropriate to the relevant task at hand. Thus, some (non-limiting) examples of devices include personal computers (desktops, laptops, netbooks, etc.), smartphones, and tablets, as well as network equipment such as routers, switches, and gateways. It should be noted that a device acting as a device in the present context is not precluded from acting as a server to other devices. The use of the expression “a device” does not preclude multiple devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers. It can be said that a database is a logically ordered collection of structured data kept electronically in a computer system

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 illustrates an example of a computing device that may be used to implement any of the methods described herein.

FIG. 2 is an exemplary schematic representation of a computer-implemented method executed by the processor of FIG. 1, in accordance with at least some non-limiting embodiments of the present technology.

FIG. 3 is an exemplary representation of a processing step of the method of FIG. 2 executed by the processor, in accordance with at least some non-limiting embodiments of the present technology.

FIG. 4 is an exemplary representation of another processing step of the method of FIG. 2 executed by the processor, in accordance with at least some non-limiting embodiments of the present technology.

FIG. 5 is an exemplary scheme-block illustration of a method executed by a processor of the computing device of FIG. 1, in accordance with at least some non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present technology.

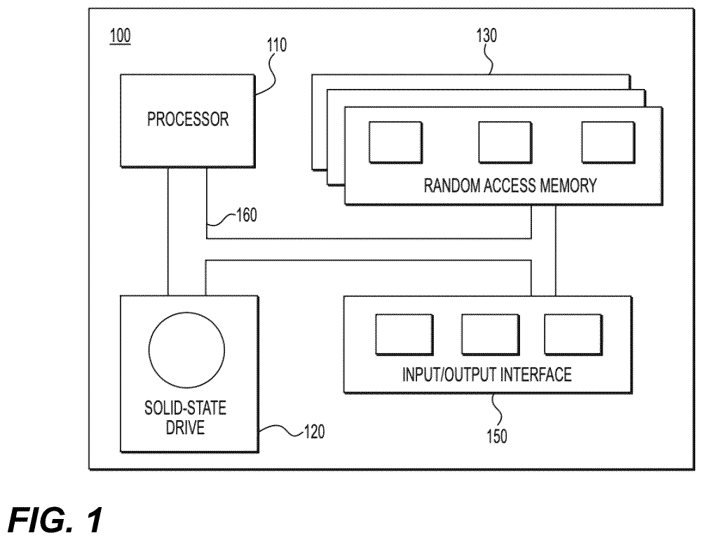

FIG. 1 illustrates a diagram of a computing environment 100 in accordance with an embodiment of the present technology is shown. In some embodiments, the computing environment 100 may be implemented by any of a conventional personal computer, a computer dedicated to operating and/or monitoring systems relating to a data center, a controller and/or an electronic device (such as, but not limited to, a mobile device, a tablet device, a server, a controller unit, a control device, a monitoring device etc.) and/or any combination thereof appropriate to the relevant task at hand. In some embodiments, the computing environment 100 comprises various hardware components including one or more single or multi-core processors collectively represented by a processor 110, a solid-state drive 120, a random access memory 130 and an input/output interface 150.

In some embodiments, the computing environment 100 may also be a sub-system of one of the above-listed systems. In some other embodiments, the computing environment 100 may be an “off the shelf” generic computer system. In some embodiments, the computing environment 100 may also be distributed amongst multiple systems. The computing environment 100 may also be specifically dedicated to the implementation of the present technology. As a person in the art of the present technology may appreciate, multiple variations as to how the computing environment 100 is implemented may be envisioned without departing from the scope of the present technology.

Communication between the various components of the computing environment 100 may be enabled by one or more internal and/or external buses 160 (e.g. a PCI bus, universal serial bus, IEEE 1394 “Firewire” bus, SCSI bus, Serial-ATA bus, ARINC bus, etc.), to which the various hardware components are electronically coupled.

The input/output interface 150 may allow enabling networking capabilities such as wire or wireless access. As an example, the input/output interface 150 may comprise a networking interface such as, but not limited to, a network port, a network socket, a network interface controller and the like. Multiple examples of how the networking interface may be implemented will become apparent to the person skilled in the art of the present technology. For example, but without being limitative, the networking interface may implement specific physical layer and data link layer standard such as Ethernet, Fibre Channel, Wi-Fi or Token Ring. The specific physical layer and the data link layer may provide a base for a full network protocol stack, allowing communication among small groups of computers on the same local area network (LAN) and large-scale network communications through routable protocols, such as Internet Protocol (IP).

In some embodiments of the present technology, the computing environment 100 may be communicatively coupled to one or more cameras (e.g., pinhole cameras, omnidirectional cameras, etc.) for receiving camera inputs and/or communicatively coupled to one or more user devices in a cloud platform for receiving camera inputs provided by users of the cloud platform.

The computing environment 100 may be communicatively coupled to an omnidirectional camera system. In one example, the computing environment 100 may receive data acquired by DreamVu PAL USB-360 3D vision system, and/or GoPro Max Lens Mod 2.0 with a fisheye lens for GoPro.

According to implementations of the present technology, the solid-state drive 120 stores program instructions suitable for being loaded into the random access memory 130 and executed by the processor 110 for executing operating data centers based on a generated machine learning pipeline. For example, the program instructions may be part of a library or an application.

In some embodiments of the present technology, the computing environment 100 may be implemented as part of a cloud computing environment. Broadly, a cloud computing environment is a type of computing that relies on a network of remote servers hosted on the internet, for example, to store, manage, and process data, rather than a local server or personal computer. This type of computing allows users to access data and applications from remote locations, and provides a scalable, flexible, and cost-effective solution for data storage and computing. Cloud computing environments can be divided into three main categories: Infrastructure as a Service (IaaS), Platform as a Service (PaaS), and Software as a Service (SaaS). In an IaaS environment, users can rent virtual servers, storage, and other computing resources from a third-party provider, for example. In a PaaS environment, users have access to a platform for developing, running, and managing applications without having to manage the underlying infrastructure. In a SaaS environment, users can access pre-built software applications that are hosted by a third-party provider, for example. In summary, cloud computing environments offer a range of benefits, including cost savings, scalability, increased agility, and the ability to quickly deploy and manage applications.

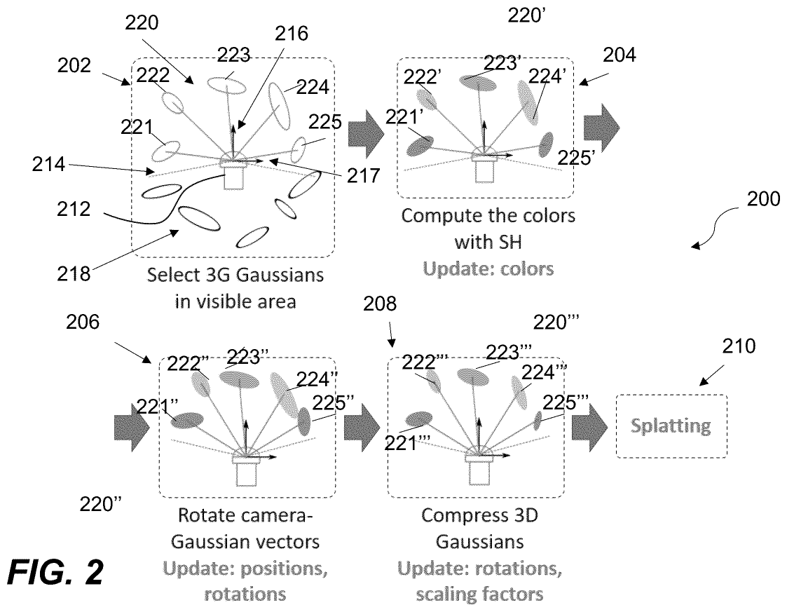

With reference to FIG. 2, there is depicted an exemplary schematic representation of a computer-implemented method 200 executed for example, by the processor 110 in some embodiments of the present technology. In some embodiments, the processor 110 may be configured to execute one or more of processing steps 202, 204, 206, 208, and 210. Broadly, in some embodiments, the processor 110 may be configured to:
as part of the processing step 202, select a sub-set of 3D Gaussians 220 including, for example, Gaussians 221, 222, 223, 224, 225;
as part of the processing step 204, compute a color of each of the sub-set of 3D Gaussian 220 using corresponding camera-Gaussian center vectors and spherical harmonics (in world frame);
as part of the processing step 206, rotate the corresponding camera-Gaussian center vectors of the sub-set of 3D Gaussians 220′ towards a camera optical axis 216, where 3D Gaussian pose rotates together with the corresponding camera-Gaussian center vectors;
as part of the processing step 208, stretch/compress the sub-set of 3D Gaussians 220″ in the polar and azimuthal directions by using eigen decomposition to get the rotation and scaling factors of each of the sub-set of processed 3D Gaussians 200″; and
as part of the processing step 210, perform a splatting operation onto one or more of the sub-set of processed 3D Gaussians 200″.

It should be noted that one or more of the processing steps 202 to 210 may be optional and/or omitted in at least some embodiments of the present technology. As it will become apparent from the description herein further below, it is contemplated that one or more additional steps to the processing steps 202 to 210 may be performed by the processor 110 when executing a method of rendering image data of an omnidirectional camera using a 3DGS model.

In at least some embodiments of the present technology, the processor 110 may be configured to access one or more omnidirectional camera models. In some embodiments, the processor 110 may be configured access a Kannala-Brandt model and/or MEI camera model. Broadly, Kannala-Brandt camera model and MEI camera model are the different modeling algorithms for modelling omnidirectional cameras. The Kannala-Brandt model may be used for modelling a dioptric camera, and MEI model may be used for model a dioptric camera and/or a catadioptric camera.

The processor 110 may be configured to employ a camera model similar to models disclosed in an article entitled “A generic camera model and calibration method for conventional, wide-angle, and fish-eye lenses” authored by J. Kannala and S. S. Brandt, published in August 2006, the content of which is incorporated herein by reference in its entirety. The processor 110 may be configured to employ a camera model similar to models disclosed in an article entitled “Single View Point Omnidirectional Camera Calibration from Planar Grids” authored by C. Mei and P. Rives, published in 2007, the content of which is incorporated herein by reference in its entirety.

When executing either the Kannala-Brandt camera model and MEI camera model, the processor 110 may be configured to perform two steps. During the first step, the processor 110 is configured to translate 3D points to new positions by rotating camera-point vectors towards an optical axis of the camera. In the context MEI model, this first step executed by the processor 110 may be called “mirror transformation” which denoted the twisting of light rays caused by lens or mirror. During the second step, the processor 110 is configured to project 3D points from their new positions to an image plane. Camera intrinsic matrix or pseudo intrinsic matrix may be used by the processor during the second step.

Developers of the present technology have realized that in the case of 3DGS models, the processor 110 needs to perform operations on 3D Gaussians, instead of moving and projecting 3D points. The rotation transformation of camera-point vectors may lead to deformation of the 3D Gaussians. Furthermore, the approximation of deformed 3D Gaussians may still need to follow a Gaussian distribution or otherwise the 3DGS may become ill-suited for real-time applications.

The processing steps 202 to 210 will now be described in greater details.

As seen in FIG. 2, the processor 110 may be configured to transfer a plurality of 3D Gaussians in including a subset of 3D Gaussians 218 and a subset of 3D gaussians 220 into a camera coordinate frame defined by anoptical axis 216 and a transverse axis 217, of a camera 212.

During the processing step 202, the processor 110 may be configured to identify and remove 3D Gaussians which are not in the Field of View (FOV) 214 of the camera 212. It can be said that the processor 110 may select the subset of 3D Gaussians 220 for further processing. The processing step 202 may reduce an overall computational cost of the method 200. The processing step may be optional and/or omitted in some embodiments of the present technology. It is contemplated that the processing steps 204 to 210 may be executed to one or more 3D Gaussians provided to and/or generated by the processing 110 without departing from the scope of the present technology.

During the processing step 204, the processor 110 may be configured to compute color data of the sub-set 3D Gaussians by using spherical harmonics and thereby generate colored sub-subset of 3D Gaussians 220′. It is contemplated that the processing step 204 may be executed by the processor 110 in a world coordinate before executing translation transformations of 3D Gaussians. Developers have realized that if the processing 110 executed the pre-processing step 2-4 not in the world frame, the parameters of spherical harmonics may need to be recomputed, and which involves computation of a Wigner-D matrix, which is computationally complex and time consuming.

During the processing step 206, the processor 110 may be configured to move the colored 3D Gaussians 220′ by rotating corresponding camera-Gaussian center vectors towards the optical axis 216 of the camera 212. Developers of the present technology have realized that the processing step 206 may have a similar effect to the effect of the lens and/or mirror of omnidirectional cameras.

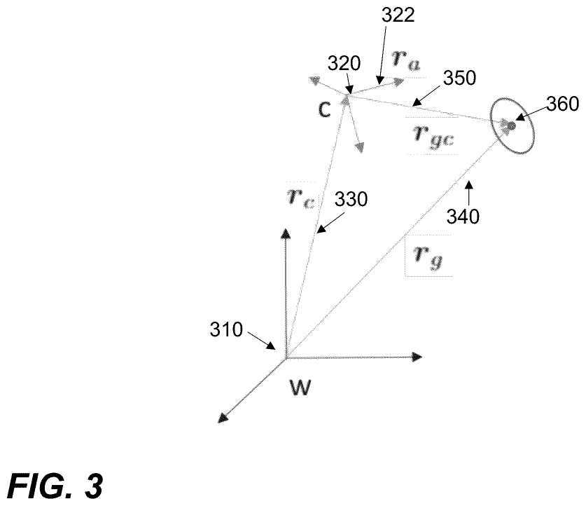

With reference to FIG. 3, there is depicted a representation of the processing step 206 executed by the processor 110 in one non-limiting embodiment of the present technology. There is depicted a world coordinate frame 310 and a camera coordinate frame 320.

The positions of a 3D Gaussian and of a camera in the world coordinate frame 310 are defined as r_{g} 340 and r_{c} 330, and the optical axis of camera is rₐ 320. During the transformation, a given camera-Gaussian center vector needs to rotate by Δθ around vector rᵣₒₜ. In this non-limiting embodiment, the processor 110 may be configured execute one or more operations in accordance with the following equations (1), (2), and (3):

$${r}_{g c} = {r}_{g} - {r}_{c} \qquad ( 1 )$$

$${r}_{r o t} = \frac{{r}_{g c}}{‖ {r}_{g c} ‖} \times {r}_{a} \qquad ( 2 )$$

$$Δθ = {θ}_{d} - θ \qquad ( 3 )$$

wherein θ is an included angle between the camera-Gaussian center vector and the optical axis of the camera rₐ 320, r_{gc} is the vector from camera to center of 3D Gaussian, r_{g} is the position of 3D Gaussian center, r_{c} is the position of camera, and rₐ is the optical axis of camera.

It should be noted that the processor 110 may make use of one or more camera models mentioned to compute θ_{d} in equation (3). In this non-limiting embodiment, the processor 110 may be configured to compute the new position of 3D Gaussian r′_{d} by executing one or more operations in accordance with the following equations (4) and (5):

$$δ q = {q}_{v e c} ( {r}_{r o t} , Δ θ ) \qquad ( 4 )$$

$${r}_{g}^{′} = C ( δ q ) {r}_{g c} + {r}_{c} \qquad ( 5 )$$

where q_{vec} is the conversion from axis-angle to quaternion (vector rotation), C(·) is the conversion from quaternion to rotation matrix.

The pose of the 3D Gaussian needs to rotate with the camera-Gaussian vector together. In this non-limiting embodiment, the processor 110 may be configured to compute a new pose (quaternion) by executing one or more operations in accordance with the following equation (6):

$${q}_{g}^{′} = δ q ⊗ {q}_{g} \qquad ( 6 )$$

Returning to the description of FIG. 2, during the processing step 208, the processor 110 may be configured to compress colored and moved subset of 3D Gaussians 220″ in the polar and tangential directions. The compression of the colored and moved subset of 3D Gaussians 220″ may be performed following the compression of the FOV 214.

Developers have realized that the processing step 208 may be executed to reduce a risk of overlap between adjacent 3D Gaussians on the spatting plane. It should be noted that a radial scale adjustment of a 3D Gaussian may be optional and/or omitted as it has a limited effect, if any, on the splatting result.

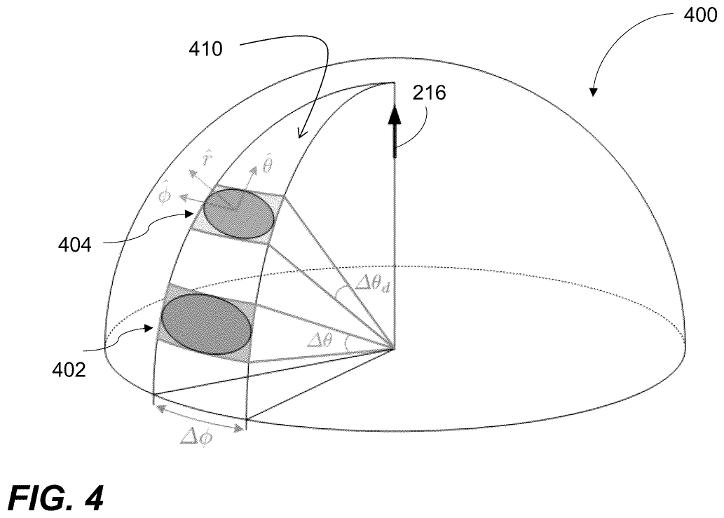

With reference to FIG. 4, there is depicted a representation of one or more processing steps executed on a given 3D Gaussian 402. The given 3D Gaussian 402 is moved along a surface of a sector 410 towards the optical axis 216 and is stretched/compressed into two directions, resulting in a processed 3D Gaussian 404. The processor 110 may be configured to compute compression/stretch ratios for one or more directions comprising a tangential direction \hat{ϕ} and a polar direction \hat{θ}.

The compression of the 3D Gaussian in a given direction can be realized with a stretching matrix in accordance with equation (7):

$$S ( \hat{n} , k ) = [ \begin{matrix}1 + ( k - 1 ) {n}_{x}^{2} , & ( k - 1 ) {n}_{x} {n}_{y} , & ( k - 1 ) {n}_{x} {n}_{z} \\ ( k - 1 ) {n}_{x} {n}_{y} , & 1 + ( k - 1 ) {n}_{y}^{2} , & ( k - 1 ) {n}_{y} {n}_{z} \\ ( k - 1 ) {n}_{x} {n}_{z} , & ( k - 1 ) {n}_{y} {n}_{z} , & 1 + ( k - 1 ) {n}_{z}^{2}\end{matrix} ] \qquad ( 7 )$$

wherein \hat{n} is the stretching direction, and k is the stretching ratio, wherein nₓ, n_{y}, and n_{z} are respective elements of \hat{n}. In one non-limiting embodiment, the processor 110 may be configured to computer a tangential stretching ratio or tangential scaling factor as

$$\frac{sin {θ}_{d}}{sin θ} .$$

Developers of the present technology have realized that a polar stretching ratio or polar scaling factor may depend on a given omnidirectional camera model being used. As mentioned above, an omnidirectional camera model usually has two parts. This first part is used to represent twist of the light ray (3D point). Its mathematic model is θ_{d}=F(θ). The second part is the pinhole camera projection model. By using the camera intrinsic matrix, the twisted 3D points are projected to the image plane. Developers of the present technology have realized that the function θ_{d}=F(θ), can be expanded into a Taylor series at the point θ₀ in accordance with the following equation (8):

$$Δ {θ}_{d} = \frac{d {θ}_{d}}{d θ} Δ θ + \frac{1}{2 !} \frac{{d}^{2} {θ}_{d}}{d {θ}^{2}} + \frac{1}{3 !} \frac{{d}^{3} {θ}_{d}}{d {θ}^{3}} + … \qquad ( 8 )$$

In this non-limiting embodiment, the processor 110 may be configured to compute the polar stretching ration as

$${k}_{θ} = \frac{Δ {θ}_{d}}{Δ θ} .$$

In an other non-limiting embodiment the processor 110 may be configured computer a linear approximation of the polar stretching ratio or polar scaling factor

$$\frac{d {θ}_{d}}{d θ} .$$

In one embodiment, the processor 110 may use θ_{d}=F(θ) function of the Kannala-Brandt model which corresponds to:

$${θ}_{d} = arctan {r}_{d} = arctan ( θ ( 1 + {k}_{1} {θ}^{2} + {k}_{2} {θ}^{4} + {k}_{3} {θ}^{6} + {k}_{4} {θ}^{8} ) ) \qquad ( 9 )$$

In this embodiment, the processor 110 may be configured to computer a linear approximation of the polar stretching ratio in accordance with the following equations (10) and (11):

$${k}_{θ} = \frac{d {θ}_{d}}{d θ} = \frac{1}{1 + {r}_{d}^{2}} \frac{{dr}_{d}}{d θ} \qquad ( 10 )$$

$$\frac{d {r}_{d}}{d θ} = 1 + 3 {k}_{1} {θ}^{2} + 5 {k}_{2} {θ}^{4} + 7 {k}_{3} {θ}^{6} + 9 {k}_{4} {θ}^{8} \qquad ( 11 )$$

In an other embodiment, the processor 110 may use θ_{d}=F(θ) function of the MEI model which corresponds to:

$$χ = \frac{sin ( θ )}{cos ( θ + ξ )} \qquad ( 12 )$$

$${θ}_{d} = arctan {r}_{d} = arctan ( χ + {k}_{1} {χ}^{3} + {k}_{2} {χ}^{5} ) \qquad ( 13 )$$

In this other embodiment, the processor 110 may be configured to compute a linear approximation of the polar stretching ratio in accordance with the following equations (14) and (15):

$${k}_{θ} = \frac{d {θ}_{d}}{d θ} = \frac{( 1 + 3 {k}_{1} {χ}^{2} + 5 {k}_{2} {χ}^{4} )}{( 1 + {r}_{d}^{2} )} \frac{d χ}{d θ} \qquad ( 14 )$$

$$\frac{d χ}{d θ} = \frac{1 + ξ cos θ}{{( cos θ + ξ )}^{2}} \qquad ( 15 )$$

Developers have realized that coefficients of the high order expansion may have an analytical form for camera models whose θ_{d}=F(θ) is continuous and differentiable.

It should be noted that the stretch/compression will change the covariance matrix. The covariance matrix after the stretch can be expressed in accordance with the following equation (16):

$${\sum }^{′} = {S}_{θ} {S}_{ϕ} \sum {S}_{ϕ}^{T} {S}_{θ}^{T} \qquad ( 16 )$$

The new scaling factors are sᵢ=\sqrt{λᵢ}, i=1, 2, 3, where λᵢ is the eigenvalues of the new covariance matrix. It should be noted that the new quaternion can be expressed in accordance with the following equation (17):

$$q = quat ( [ v 1 , v 2 , v 1 \times v 2 ] \qquad ( 17 )$$

wherein vᵢ are the eigenvectors of the new covariance matrix. quat( ) is the conversion from rotation matrix to quaternion.

In summary, the subset of 3D Gaussians 220 are transformed in turn into: the subset of colored 3D Gaussians 220′, the subset of colored and moved 3D Gaussians 220″ and, a subset of colored, moved and compressed 3D Gaussians 220′″. During these transformations, positions, rotations and scaling factors of the original subset of 3D Gaussians 220 are updated. The colors and opacities may remain unchanged.

During the processing step 310, the processor 110 may be configured to splat a one or more transformed 3D Gaussians to the image plane by using a 3DGS model. The original parallelization strategy of a given 3DGS model may remain unchanged.

In some embodiments of the present technology, the method 200 may be employed as part of pre-processing steps for preparing data for input into a 3DGS model. Data processing in accordance with the method 200 is differentiable and may does not affect the original 3DGS framework. Therefore, developers have realized that the images of omnidirectional cameras can be used in training of 3D reconstruction models.

It should be noted that each pixel in an image corresponds to a frustum in 3D space. In comparison with pinhole cameras, omnidirectional cameras may have a larger difference in a size of frustum from one pixel to another. For example, pixels far from the center correspond to bigger frustums. This means that 3D Gaussians usually projected in the pixels far from the center will get lower gradients, and they will converge more slowly. Developers have realized that 3D Gaussians which are further from the center of the object can be more blurry than 3D Gaussians which are nearer to the center of the object.

In at least some embodiments of the present technology, there is provided a weight mask for balancing the converge speed where pixels farther from the center are assigned with comparatively higher weights that pixels closer to the center. The processor 110 may be configured to compute a value of the weight in accordance with following equation (18):

$$\frac{d θ \cdot sin θ}{d {θ}_{d} \cdot sin {θ}_{d}} \qquad ( 18 )$$

It can be said that the weight is a reciprocal representation of the compression ratio of the corresponding frustum sectional area. The processor 110 may be configured to compute a new loss function in accordance with the following equation (19):

$$ℒ = ( 1 - λ ) {ℒ}_{1} ( {W}_{m} ) + λ {ℒ}_{D - SSIM} \qquad ( 19 )$$

wherein L₁(wₘ) is the weighted L1 loss. The weight mask is fixed for a camera and therefore needs to be computed only once. It is contemplated that the weight mask may be used by the processor 110 to balance the gradients of 3D Gaussians projected in edge pixels. As a result, the convergence speed of 3D Gaussians in different positions can be balanced/controlled and the overall training speed can be increased.

In one implementation of the present technology, the weight mask may be computed by the processor 110 as a matrix, whose size is the same to that of the rendering image. L_1 loss can be computed in 2 steps. First, the processor 110 may compute the difference between the rendering result and ground truth—the output of this step is a matrix. Second, the processor 110 may compute the mean value of the output matrix. The processor 110 may combine, via element-wise product for example, the Output_matrix times Weight_mask.

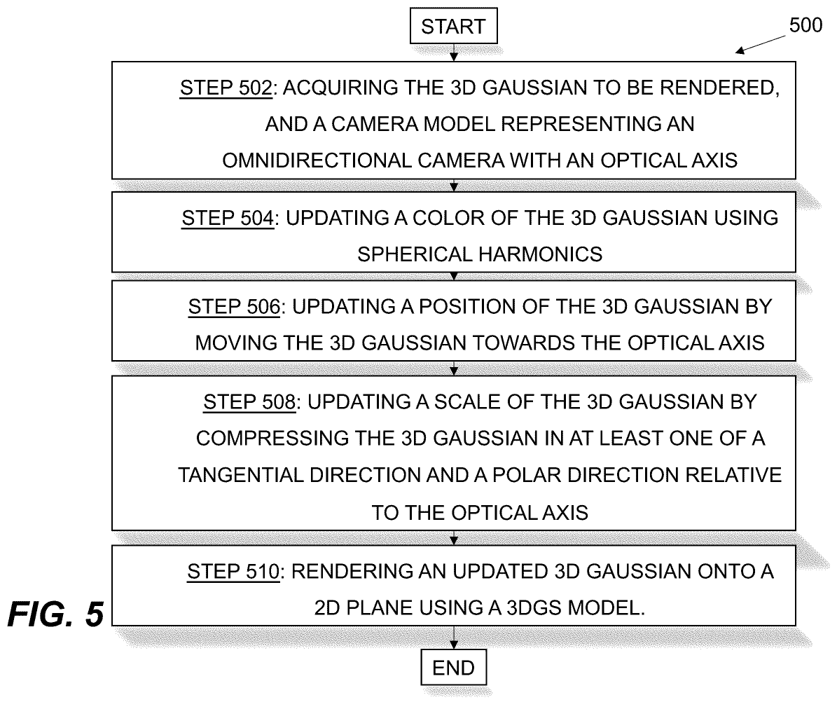

In some embodiments of the present technology, the processor may be configured to execute steps of a method 500, the scheme-block representation of which is illustrated in FIG. 5. It is contemplated that the processor 110 may be configured to execute additional steps to those illustrated in FIG. 5, without departing from the scope of the present technology. Various steps of the method 500 will now be described.

Step 502: Acquiring the 3D Gaussian to be Rendered, and a Camera Model Representing an Omnidirectional Camera with an Optical Axis

The method 500 begins at step 502 with the processor 110 configured to acquire a 3D Gaussian to be rendered, and a camera model representing an omnidirectional camera with an optical axis. For example, the processor 110 may be configured to acquire one or more 3D Gaussians, such as the 3D Gaussian 223 seen in FIG. 2. The representation of the omnidirectional camera 212 relative to the 3D Gaussian 223 is also illustrated with the optical axis 216 and the transverse axis 217.

In some embodiments, the processor 110 may acquire a plurality of 3D Gaussians and select a sub-set of 3D Gaussians amongst the plurality of 3D Gaussians using the FOV associated with the camera model and/or the omnidirectional camera representation. The selected sub-set may be referred to as a visible subset of 3D Gaussians which the processor 110 may be configured to transform prior to rendering operations.

In some embodiments, the processor 110 may be configured to employ an MEI camera model. In other embodiments, the processor 110 may be configured to employ a Kannala-Brandt camera model. However, other camera models may be employed by the processor 11 without departing form the scope of the present technology.

### Step 504: Updating a Color of the 3D Gaussian Using Spherical Harmonics

The method 500 continues to step 504 with the processor 110 configured to update the color of the 3D Gaussian using spherical harmonics.

In some embodiments, the processor 110 may be configured to compute color data of the sub-set 3D Gaussians by using spherical harmonics and thereby generate colored sub-subset of 3D Gaussians 220′. The processor 110 may be configured to compute color data in a world coordinate before executing translation transformations of 3D Gaussians.

### Step 506: Updating a Position of the 3D Gaussian by Moving the 3D Gaussian Towards the Optical Axis

The method 500 continues to step 506 with the processor 110 configured to update a position of the 3D Gaussian by moving the 3D Gaussian towards the optical axis. For example, in FIG. 2, there is depicted the moved and colored 3D Gaussian 223″ generated by the processor 110 for the (initial) corresponding 3D Gaussian 223.

The new position of the moved and colored 3D Gaussian 223″ is closer to the optical axis 216 than the initial position of the 3D Gaussian 223. It is contemplated that the processor 110 may be configured to rotate the corresponding camera-Gaussian center vectors of the sub-set of 3D Gaussians 220′ towards the camera optical axis 216.

### Step 508: Updating a Scale of the 3D Gaussian by Compressing the 3D Gaussian in at Least One of a Tangential Direction and a Polar Direction Relative to the Optical Axis

The method 500 continues to step 508 with the processor 110 configured to update a scale of the 3D Gaussian by compressing the 3D Gaussian in at least one of a tangential direction and a polar direction relative to the optical axis of the omnidirectional camera.

In some embodiments, the processor 110 may be configured to compress colored and moved subset of 3D Gaussians 220″ in the polar and tangential directions. The compression of the colored and moved subset of 3D Gaussians 220″ may be performed following the compression of the FOV 214. Developers have realized that the processing step 208 may be executed to reduce a risk of overlap between adjacent 3D Gaussians on the spatting plane. It should be noted that a radial scale adjustment of a 3D Gaussian may be optional and/or omitted as it has a limited effect, if any, on the splatting result.

With reference to FIG. 4, the processor 110 may be configured to compute compression/stretch ratios for one or more directions comprising a tangential direction ϕ and a polar direction θ.

In some embodiments, the processor 110 may be configured to generate at least one of a tangential scaling factor and a polar scaling factor and update the scale based on the at least one of the tangential scaling factor and the polar scaling factor.

In other embodiments, the polar scaling factor being model-specific to the camera model. For example, the polar scaling factor may be different for a first camera model and a second camera models.

In further embodiments, the processor 110 may update the scale of a given 3D Gaussian by generating a rescaled 3D Gaussian being smaller in size along the tangential direction than the 3D Gaussian. In additional embodiments, the processor 110 may update the scale of a given 3D Gaussian by generating a rescaled 3D Gaussian being smaller in size along the polar direction than the 3D Gaussian.

For example, as seen in FIG. 4, the given 3D Gaussian 402 is moved along a surface of a sector 410 towards the optical axis 216 and is compressed into two directions, simultaneously resulting in a processed 3D Gaussian 404.

Step 510: Rendering an Updated 3D Gaussian onto a 2D Plane Using a 3DGS Model

The method 500 continues to step 510 with the processor 110 configured to render an updated 3D Gaussian onto a 2D plane using a 3DGS model. For example, the colored, moved, compressed 3D Gaussian 223′″ is sent to a renderer for projection in a form of a 2D image.

In some embodiments, the processor 110 may be configured to generate and apply a weighted matric onto the rendered 3D Gaussian. The weighted matrix may have elements corresponding to respective pixels of the renderer image. The weights may be attributed based on inter ilia the distance of the pixel from the center of the image.

In additional embodiments, the processor 110 may be configured to generate a plurality of rendered 3D Gaussians based on a plurality of initial 3D Gaussians. The processor 110 may use this data for generating a training dataset for training a machine learning model to perform 3D scene reconstruction.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of rendering a 3D Gaussian, the method executable by a processor, the method comprising:
acquiring the 3D Gaussian to be rendered, and a camera model representing an omnidirectional camera with an optical axis;
updating a color of the 3D Gaussian using spherical harmonics;
updating a position of the 3D Gaussian by moving the 3D Gaussian towards the optical axis;
updating a scale of the 3D Gaussian by compressing the 3D Gaussian in at least one of a tangential direction and a polar direction relative to the optical axis; and
rendering an updated 3D Gaussian onto a 2D plane using a 3DGS model.

2. The method of claim 1, wherein the 3D Gaussian is a subset of 3D Gaussians, the omnidirectional camera further having a Field of View (FOV), and wherein the method further comprises:
acquiring a plurality of 3D Gaussians;
selecting the sub-set of 3D Gaussians amongst the plurality of 3D Gaussians using the FOV, the selected sub-set being a visible subset of 3D Gaussians.

3. The method of claim 1, wherein the updating the position of the 3D Gaussian comprises:
rotating a camera-Gaussian center vector of the 3D Gaussian towards the optical axis.

4. The method of claim 1, wherein the method further comprises:
applying a weighted matrix on a rendered 3D Gaussian for controlling convergence speed of respective pixels of the rendered 3D Gaussian.

5. The method of claim 1, wherein the updating the scale of the 3D Gaussian comprises:
generating at least one of a tangential scaling factor and a polar scaling factor, the polar scaling factor being model-specific to the camera model; and
update the scale based on the at least one of the tangential scaling factor and the polar scaling factor.

6. The method of claim 5, wherein the updating the scale further includes:
generating a rescaled 3D Gaussian being smaller in size along the tangential direction than the 3D Gaussian.

7. The method of claim 5, wherein the updating the scale further includes:
generating a rescaled 3D Gaussian being smaller in size along the polar direction than the 3D Gaussian.

8. The method of claim 1, wherein the camera model is MEI camera model.

9. The method of claim 1, wherein the camera model is Kannala-Brandt camera model.

10. The method of claim 1, wherein the method further comprises:
generating a training dataset including the rendered 3D Gaussian; and
training a machine learning model using the training dataset for 3D scene reconstruction.

11. A processor for rendering a 3D Gaussian, the processor being configured to:
acquire the 3D Gaussian to be rendered, and a camera model representing an omnidirectional camera with an optical axis;
update a color of the 3D Gaussian using spherical harmonics;
update a position of the 3D Gaussian by moving the 3D Gaussian towards the optical axis;
update a scale of the 3D Gaussian by compressing the 3D Gaussian in at least one of a tangential direction and a polar direction relative to the optical axis; and
render an updated 3D Gaussian onto a 2D plane using a 3DGS model.

12. The processor of claim 11, wherein the 3D Gaussian is a subset of 3D Gaussians, the omnidirectional camera further having a Field of View (FOV), and wherein the processor is further configured to:
acquire a plurality of 3D Gaussians;
select the sub-set of 3D Gaussians amongst the plurality of 3D Gaussians using the FOV, the selected sub-set being a visible subset of 3D Gaussians.

13. The processor of claim 11, wherein to update the position of the 3D Gaussian the processor is configured to:
rotate a camera-Gaussian center vector of the 3D Gaussian towards the optical axis.

14. The processor of claim 11, wherein the processor is further configured to:
apply a weighted matrix on a rendered 3D Gaussian for controlling convergence speed of respective pixels of the rendered 3D Gaussian.

15. The processor of claim 11, wherein to update the scale of the 3D Gaussian the processor is configured to:
generate at least one of a tangential scaling factor and a polar scaling factor, the polar scaling factor being model-specific to the camera model; and
update the scale based on the at least one of the tangential scaling factor and the polar scaling factor.

16. The processor of claim 15, wherein to update the scale the processor is further configured to:
generate a rescaled 3D Gaussian being smaller in size along the tangential direction than the 3D Gaussian.

17. The processor of claim 15, wherein to update the scale the processor is further configured to:
generate a rescaled 3D Gaussian being smaller in size along the polar direction than the 3D Gaussian.

18. The processor of claim 11, wherein the camera model is one of a MEI camera model and a Kannala-Brandt camera model.

19. The processor of claim 11, wherein the processor is further configured to:
generate a training dataset including the rendered 3D Gaussian; and
train a machine learning model using the training dataset for 3D scene reconstruction.

20. One or more non-transitory, computer-readable storage media comprising computer-executable instructions, wherein the instructions, when executed, cause one or more processors to:
acquire the 3D Gaussian to be rendered, and a camera model representing an omnidirectional camera with an optical axis;
update a color of the 3D Gaussian using spherical harmonics;
update a position of the 3D Gaussian by moving the 3D Gaussian towards the optical axis;
update a scale of the 3D Gaussian by compressing the 3D Gaussian in at least one of a tangential direction and a polar direction relative to the optical axis; and
render an updated 3D Gaussian onto a 2D plane using a 3DGS model.
